(19) United States
(12) Patent Application Publication
(10) Pub. No.: US 2009/0100025 A1
(43) Pub. Date: Apr. 16, 2009

(54) Apparatus and Method for Selectively Viewing Data

(76) Inventor: Adam Binnie, Bowen Island (CA)

Correspondence Address: SAP Global c/o Cooley Godward Kronish LLP;William S. Galliani, 777 6th Street NW, Suite 1100, Washington, DC, 20001, US

(21) Appl. No.: 12/249,815

(22) Filed: Oct. 10, 2008

Related U.S. Application Data
(60) Provisional application No. 60/979,793, filed on Oct. 12, 2007.

(51) Int. Cl. G06F 7/06; G06F 17/30

(52) U.S. Cl. 707/3; 707/E17.014

(57) ABSTRACT

A computer readable storage medium includes executable instructions to associate different entities with different entity classes. Each entity class has an associated set of lenses. Each lens includes metadata characterizing data presentation directives. User criteria is analyzed to deliver a subset of lenses to a user. Each lens includes executable instructions to display to a user a subset of information from a data source in accordance with the data presentation directives.

### CROSS-REFERENCE TO RELATED APPLICATION

This application claims priority to U.S. Provisional Patent Application No. 60/979,793 filed Oct. 12, 2007, entitled “Apparatus and Method for Utilizing Data Lenses to Access Data”, the contents of which are incorporated herein.

### BRIEF DESCRIPTION OF THE INVENTION

This invention relates generally to data processing. More particularly, the invention relates to techniques for viewing data classified and organized in accordance with user criteria.

### BACKGROUND OF THE INVENTION

The ability for users to efficiently access data is important in many aspects of business, education, entertainment and other types of computer applications. As the volume and type of data increases, providing users with tools to access, analyze and manage data becomes increasingly important.

Existing approaches to analyze and organize data in a system typically involve the use of visualization tools such as reports and dashboards. Reports and dashboards enable users to interact with various entities in a system, such as objects and records in a database and provide users with a visual analysis of data results. However, users requiring multiple visual data representations of the data results typically need to interact with multiple user interfaces in order to analyze and view their data results.

It would be desirable to develop a technique to efficiently classify and organize the visual representation of information in a system. It would also be desirable to develop a technique by which users can efficiently interact with this information in accordance with each user's requirements.

### SUMMARY OF THE INVENTION

The invention includes a computer readable storage medium with executable instructions to associate different entities with different entity classes. Each entity class has an associated set of lenses. Each lens includes metadata characterizing data presentation directives. User criteria is analyzed to deliver a subset of lenses to a user. Each lens includes executable instructions to display to a user a subset of information from a data source in accordance with the data presentation directives.

### BRIEF DESCRIPTION OF THE FIGURES

The invention is more fully appreciated in connection with the following detailed description taken in conjunction with the accompanying drawings, in which:

FIG. 1 illustrates a computer system configured in accordance with an embodiment of the invention.

FIG. 2 is an exemplary data schema illustrating entity classes and lenses associated with an entity, in accordance with one embodiment of the present invention.

FIG. 3 is an exemplary data schema illustrating entity classes and lenses associated with an entity, in accordance with another embodiment of the present invention.

FIG. 4 illustrates data processing operations for generating a data schema, in accordance with one embodiment of the invention.

FIG. 5 illustrates exemplary processing operations for displaying a set of lenses associated with an entity, in accordance with one embodiment of the present invention.

FIG. 6 is an exemplary illustration of the manner in which different lenses are delivered to different users based upon user criteria associated with an entity request.

FIG. 7 illustrates an exemplary set of lenses displayed in accordance with an entity request from a user.

FIG. 8 illustrates an exemplary set of lenses displayed in accordance with another entity request from a user.

Like reference numerals refer to corresponding parts throughout the several views of the drawings.

### DETAILED DESCRIPTION OF THE INVENTION

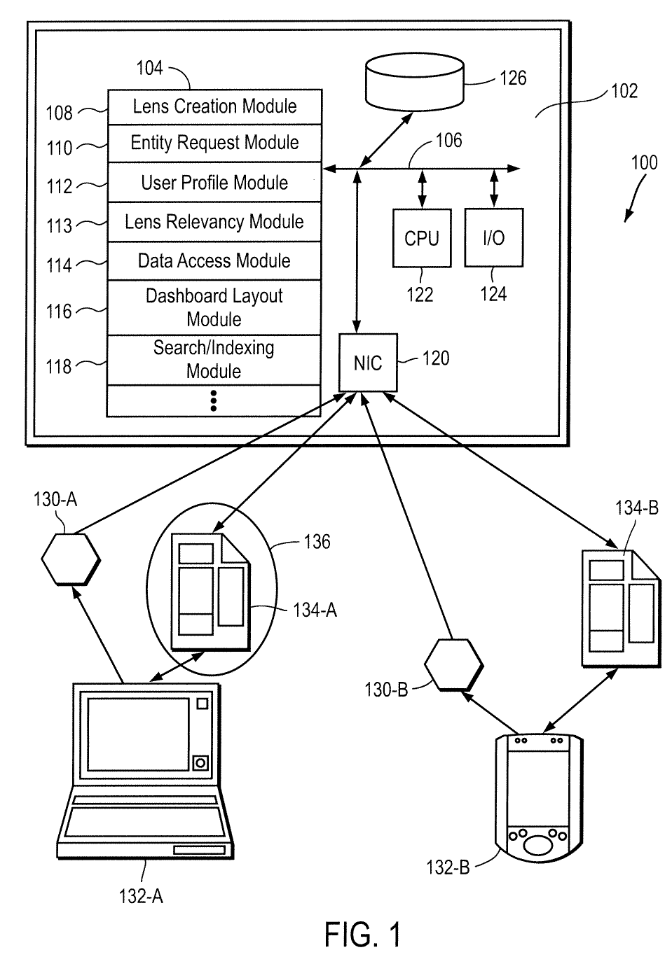

FIG. 1 illustrates a computer system configured in accordance with an embodiment of the invention. The system 100 includes a server computer 102 connected to a set of client devices 132-A, 132-B. The server computer 102 includes standard components, such as a central processing unit (CPU) 122, input/output devices 124, and a network interface circuit (NIC) 120 connected via a bus 106. The input/output devices 124 may include a keyboard, mouse, display, printer and the like. The NIC 120 supports network communication, such as with clients 132-A and 132-B. A data source 126 is also connected to the bus 106.

A memory 104 is connected to the bus 106. The memory 104 includes executable instructions to support operations associated with embodiments of the present invention. In one embodiment, the memory 104 includes a Lens Creation Module 108, an Entity Request Module 110, a User Profile Module 112, a Lens Relevancy Module 113, a Data Access Module 114, a Dashboard Layout Module 116 and a Search/Indexing Module 118.

The Lens Creation Module 108 includes executable instructions to define one or more lenses for an entity class associated with an entity. In one embodiment, a lens includes metadata characterizing data presentation directives. Each lens further includes executable instructions to display a subset of information from a data source to a user, in accordance with the data presentation directives. Data lenses may be characterized as a set of semantic rules to filter, sort, group, summarize and format data. A data lens may be implemented as a set of metadata specifying an entity or entity class for which the lens is appropriate. The metadata may include information about what entities the data lens can accept as parameters. It may also include information on how to process an entity and how to render useful information about the entity. The metadata may include security information, for example specifying who can utilize the lens.

The Entity Request Module 110 includes executable instructions to receive an entity request from a user, analyze the entity request in accordance with a set of user criteria and deliver a subset of entities, a subset of entity classes and a subset of lenses in accordance with the user criteria. The user criteria may include, but is not limited to, profile criteria, relevance criteria, access criteria and aesthetic criteria. In one embodiment, the Entity Request Module 110 is coupled to a User Profile Module 112 and a Lens Relevancy Module 113.

In a particular embodiment, the Entity Request Module 110 includes executable instructions to derive profile criteria based on user profile information stored in the User Profile Module 112 and relevance criteria based on user relevancy information stored in the Lens Relevancy Module 113. The user profile information may include, for example, previous lens selections made by a user, user identity information, user group membership information and user permissions. The relevancy information includes information about the relevancy of presenting a set of lenses to a user based on a history of the usage of a particular set of lenses by the user.

In certain embodiments, the Entity Request Module 110 further includes executable instructions to derive access criteria associated with an entity request based on user security information stored in a lens, or security information stored within an Enterprise Reporting Platform system, a Business Intelligence platform or a database. The Entity Request Module 110 may also include executable instructions to derive aesthetic criteria associated with an entity request based on aesthetic information such as value metrics associated with each lens, user lens display size preferences, trusted lens ratings, language relevance of a lens, data freshness associated with a lens, trust level of the lens creator, trust level of the data provided by the lens, optimal display size of the lens, hierarchical relationships between entity classes and so forth.

The Data Access Module 114 includes executable instructions to access data associated with an entity; the data may be stored in the data source 126. The Dashboard Layout Module 116 includes executable instructions to display a subset of information from the data source 126 to a user in accordance with data presentation directives. The Search and Indexing Module 118 includes executable instructions to search for and perform indexing operations related to entities, entity classes and lenses. In one embodiment, the Search and Indexing Module 118 may be coupled to the User Profile Module 110 to enable the access of stored user information, such as security rights, preferences and usage history.

Operationally, in one embodiment of the present invention, the computer 102 pushes data 134-A and 134-B to client devices 132-A and 132-B. The data 134-A and 134-B may include, for example, entity and lens information. The data 134-A and 134-B is processed, formatted and displayed in accordance with the entity and lens information. In one embodiment, the client devices 132-A and 132-B may include thin clients or thick clients with a corresponding division of processing between the server and the client. In one embodiment, the data 134-A may be processed, formatted and displayed in accordance with a lens 136. Alternatively, the computer 102 may also apply a lens to the data 134-B prior to displaying the data. The computer 102 also receives entity requests 130-A and 130-B from client devices 132-A and 132-B. Each entity request is then processed in accordance with a set of user criteria, as discussed above.

The modules in memory 104 are exemplary. The functions of individual modules may be combined. Alternately, the modules may be distributed across a network. It is the functions of the modules that are significant, not the particular implementation or location of any module.

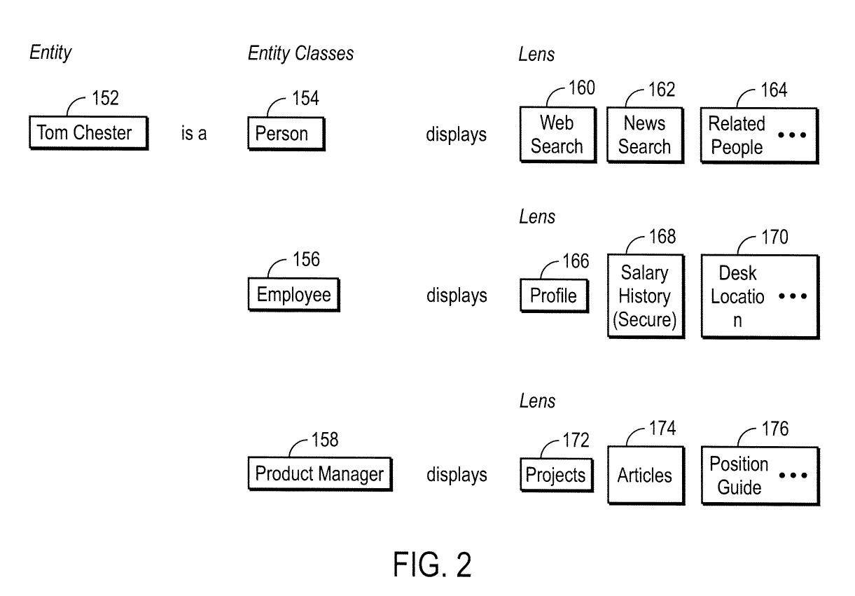

FIG. 2 is an exemplary data schema illustrating entity classes and lenses associated with an entity, in accordance with one embodiment of the present invention. Entities may include, for example, people, countries, companies or business projects. Each lens includes metadata characterizing data presentation directives for a set of entity classes associated with a set of entities. The data presentation directives may include, for example, the entity class associated with the lens, the type of information displayed to a user about an entity, the manner in which the user may interact with that information (user security information) and lens usage information of the user requesting the entity.

For example, Profile 166 and Desk Location 170 are lenses associated with the entity class Employee 156 and include metadata that characterize profile information and desk location information about the entity “Tom Chester” 152. Salary History (Secure) 168 is a lens associated with the entity class Employee 156 that includes metadata that characterizes salary information about the entity “Tom Chester”. This information is subject to security restrictions specified by the lens.

The lenses Web Search 160, News Search 162 and Related People 164 include data presentation directives characterizing the entity class Person 154 associated with the entity “Tom Chester”. The lenses, Projects 172, Articles 174 and Position Guide 176 include data presentation directives characterizing the entity class Product Manager 158 associated with the same entity. The schema of FIG. 2 may be presented to a user. Alternately, a subset of the information may be presented to a user, such as the lenses and the entity.

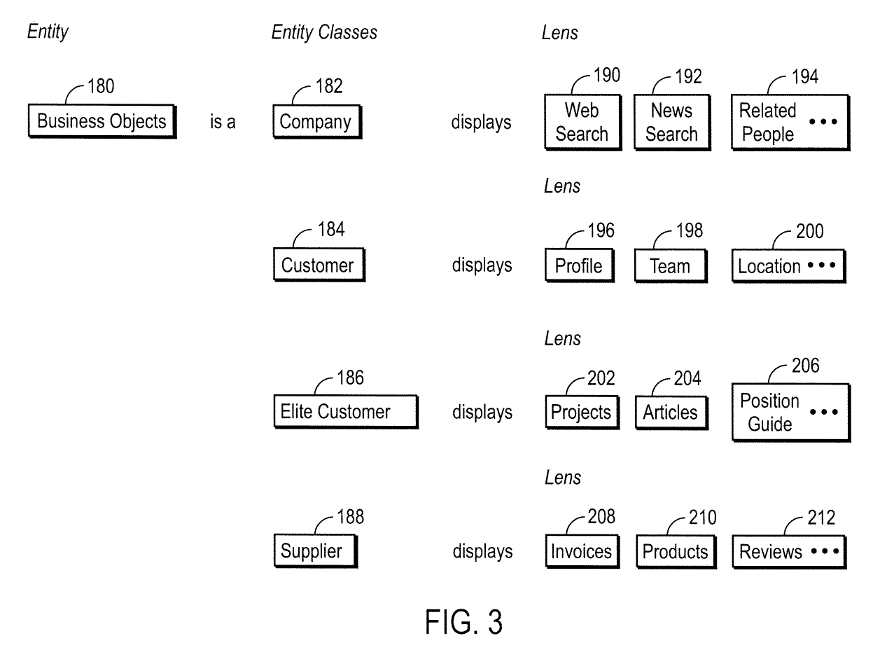

FIG. 3 is an exemplary data schema illustrating entity classes and lenses associated with an entity, in accordance with another embodiment of the present invention. The lenses Web Search 190, News Search 192 and Related People 194 are associated with the entity class Company 182, which is associated with the entity “Business Objects” 180. The lenses Profile 196, Team 198 and Location 200 are associated with the entity class Customer 184. The lenses Projects 202, Articles 204 and Position Guide 206 are associated with the entity class Elite Customer 186. Similarly, the lenses Invoices 208, Products 210 and Reviews 212 are associated with the entity class Supplier 188. Thus, it can be appreciated that the entity Business Objects 180 has an associated set of classes 182-188. Each entity class has an associated set of lenses.

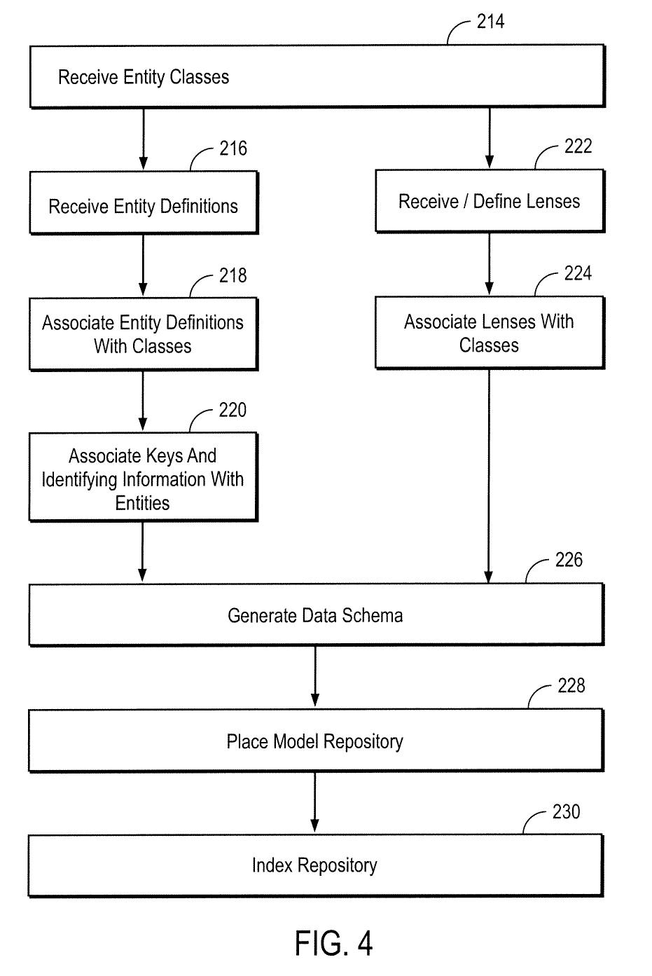

FIG. 4 illustrates data processing operations for generating a data schema in accordance with one embodiment of the invention. One or more entity classes are received 214. In one embodiment, the entity classes may be specified by a user or an administrator. In another embodiment, the entity classes may be derived from an abstraction layer, such as a semantic layer. As used herein, a “semantic layer” refers to a data foundation overlying a data source that provides terms and abstract logic associated with the underlying data source in order to manage, manipulate and analyze the data in the data source. The entity classes may also be specified based on a discovery process, such as an unstructured text analysis.

One or more entity definitions are received 216. In one embodiment, the entity definitions may be received in response to a user specified definition for an entity classes. In another embodiment, the entity definitions may be received from an existing repository or data source. The entity definitions are associated with the entity classes 218. Keys, attributes and other identifying information are then associated with the entities 220.

Lenses are received or defined 222. The lenses may be automatically generated for an entity class based on characteristics of the entity class. Alternately, the lenses may be specified to support general operations (e.g., search, accounting operations, etc.) The lenses are then associated with the entity classes 224. As shown in FIGS. 2 and 3, various entity classes have associated data lenses. A single data lens may be associated with a number of entity classes and/or entities.

A data schema is generated based on the entity classes and lenses 226. FIGS. 2 and 3 illustrate exemplary data schemas. The data schema is placed in a repository 228. In one example, the repository may be the data source 126 of the computer 102. More than one data repository may be used, either internal or external to the computer 102. The repository is then indexed 230.

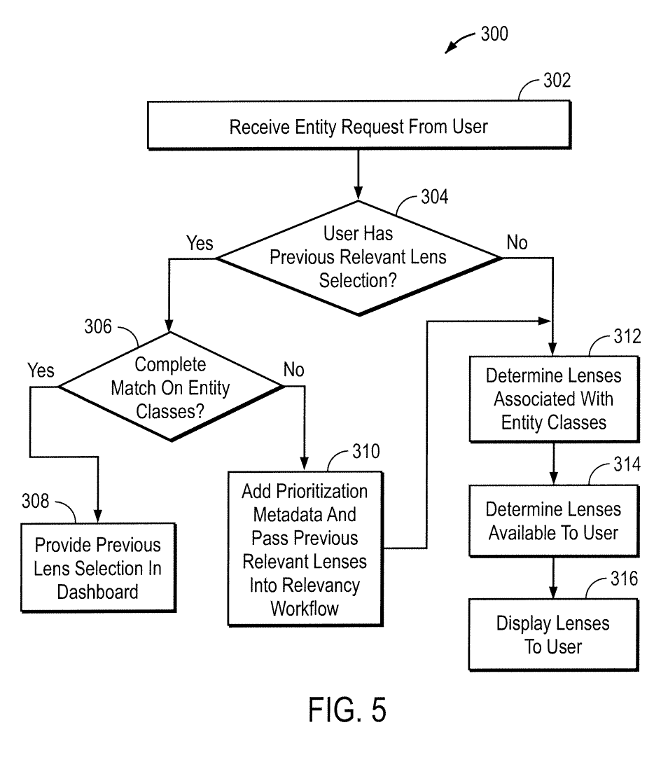

FIG. 5 illustrates exemplary processing operations for displaying a set of lenses associated with an entity in accordance with one embodiment of the invention. An entity request is received from a user 302. The entity request may include the entire name or the partial name of the entity as invoked by the user. In one embodiment, the Entity Request Module 110 includes executable instructions to receive an entity request from a user, analyze the entity request in accordance with a set of user criteria and deliver a subset of entities, entity classes and lenses in accordance with the set of user criteria. The operations performed by the Entity Request Module 110 are discussed in greater detail with respect to operations 304-316 described below.

The existence of previous lens selections for the user is determined 304. For example, a user may have customized the lenses and/or dashboard when searching for an entity with the same entity class as the current entity. If previous lens selections do not exist for the user (304-NO), all the lenses associated with the entity class are determined 312.

If previous lens selections exist for a user (304-YES), then it is determined if the previous lens selections for the user completely match a corresponding entity class 306. If a complete match with a corresponding entity class exists (306-YES), the previous lens selections are supplied to a dashboard 308. If a complete match with a corresponding entity class does not exist (306-NO), the previous lens selections that match the entity class for the entity are ranked with prioritization metadata associated with other lenses to determine the set of lenses to be displayed to the user 310. For example, a partial match may exist when an entity belongs to more than one entity class. The previous lens selections are then combined with all the lenses associated with the entity class 312.

The set of available lenses for the user is then determined 314. Availability may be defined at an individual or group level for each user. In one embodiment, the set of available lenses for the user is determined based on the user criteria. The entity request is analyzed in accordance with the user criteria and a set of lenses are displayed to the user 318. In one embodiment, the analysis includes assigning a weight factor to one or more user criteria associated with the entity request, determining a cumulative relevancy of displaying a particular lens to a user based on the weight factor and displaying a ranked set of lenses to the user in accordance with the cumulative relevancy determined for each lens.

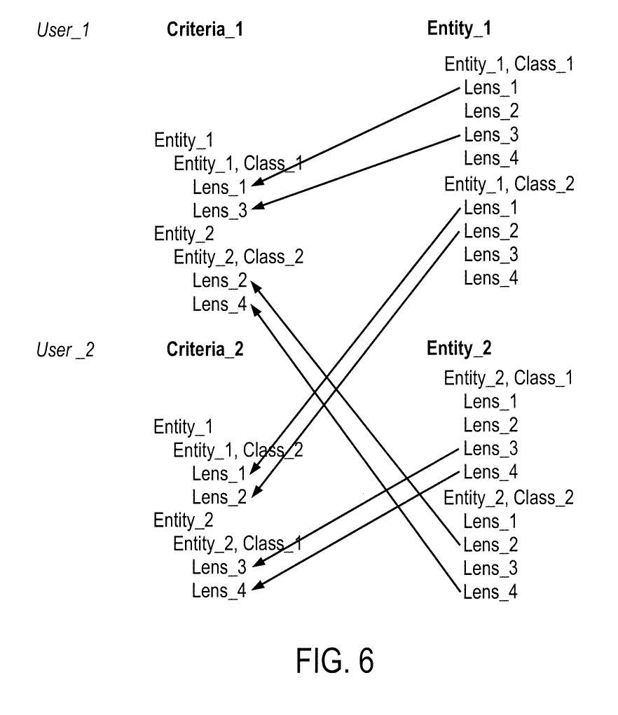

FIG. 6 is an exemplary illustration of the manner in which different lenses are delivered to different users based upon user criteria associated. In one embodiment, the Entity Request Module 110 includes executable instructions to receive an entity request from a user, analyze the entity request in accordance with a set of user criteria and deliver a subset of entities, a subset of entity classes and a subset of lenses in accordance with the user criteria. In the illustrated example, based on user criteria, Criteria_1, a first user, User_1, receives a subset of entity classes, Entity_, Class_1 and Entity_2, Class_2 and an associated subset of lenses, Lens_1, Lens_3 and Lens_2, Lens_4. Similarly, based on user criteria, Criteria_2, a second user, User_2, receives a subset of entity classes Entity_1, Class_2 and Entity_2, Class_1 and an associated subset of lenses, Lens_1, Lens_2 and Lens_3, Lens_4.

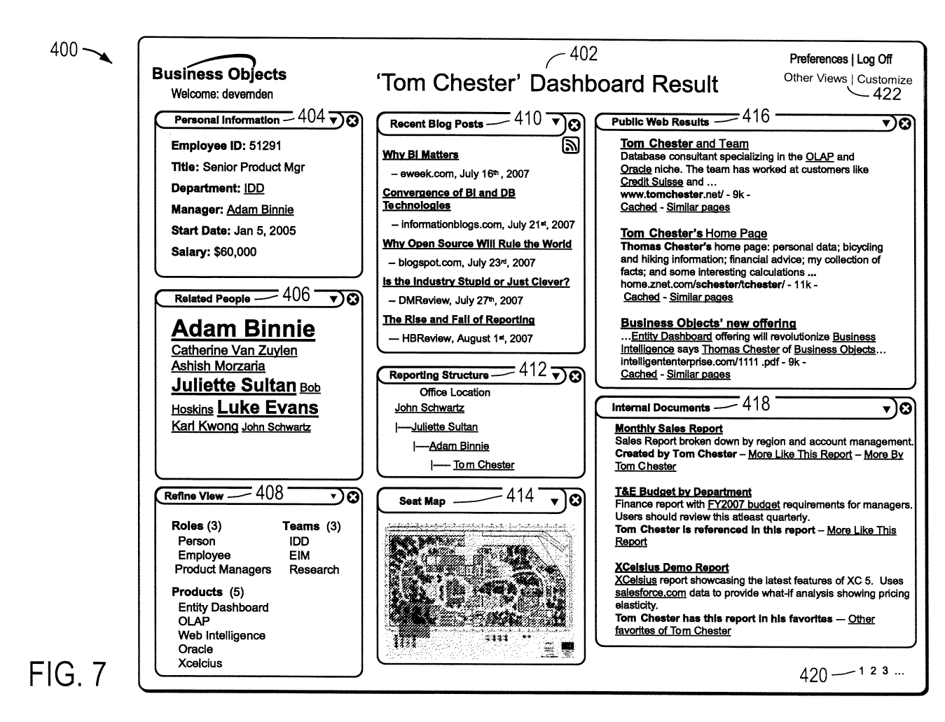

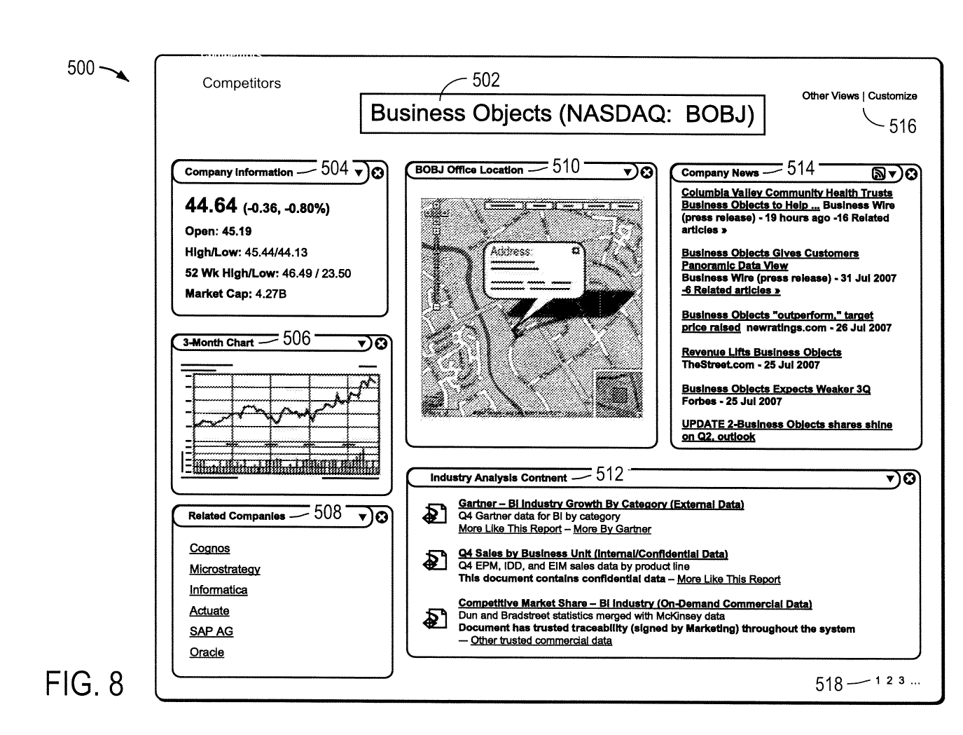

In one embodiment, and as further illustrated in FIGS. 7 and 8, the subset of lenses may be displayed and combined in a client viewer, such as a dashboard. The user may set preferences for the number and layout of the lenses provided in the dashboard. The user may also interact with the dashboard, for example, by changing specific lenses, selecting different lens views, and so forth.

FIG. 7 illustrates a set of lenses associated with the entity ‘Tom Chester’ 402. The lenses include a personal information lens 404, a related people (e.g., person and employee) lens 406, a refine view lens 408, a recent blog posts lens 410, a reporting structure lens 412, a seat map lens 414, a public web results lens 416 and an internal documents lens 418.

The personal information lens includes personal information about the entity. The related people lens includes information about people related to the entity. The refine view lens 408 indicates other available lenses to view information about the entity. The blog post lens 410 includes information about blog posts either authored by the entity or that mention the entity. The reporting structure lens 412 includes information about the entity's reporting structure. The public web results lens 416 includes web results for the entity. The internal documents lens 418 includes information about documents in the business organization associated with the entity.

The user may further interact with the information present in a lens by activating one or more links embedded in the information provided by the lens. Further, one or more buttons 420 may be used to supply additional dashboard pages of lenses that can be viewed for the entity. Button 422 provides functionality to select other views and to customize the current view. A customized view, such as dashboard 400, may be saved as a potential previous relevant lens selection. A usage history of viewing the dashboard (without interaction to customize or save the view) can be saved by the User Profile Module 110 to provide a previous relevant lens selection for the user.

FIG. 8 illustrates an exemplary set of lenses displayed in accordance with another entity. As illustrated, lenses associated with the entity ‘Business Objects’ 502 are displayed in a dashboard. The company information lens 504 displays stock information related to the entity. The three-month chart lens 506 displays stock trend information related to the entity. The related companies lens 508 lists competitors in the field of business intelligence software related to the entity. The office location lens 510 provides information about the physical location of the entity. The industry analysis lens 512 analyses information about industries related to the entity. A company news lens 514 provides news related to various related classes (e.g., person, product, role, sector, etc.) associated with the entity. Additional dashboard pages may be available by invoking buttons 518. Button 516 invokes functionality to select other views and to customize the current view related to the entity.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
associate a plurality of entities with a plurality of entity classes, wherein each entity class has an associated set of lenses, each lens including metadata characterizing data presentation directives; and
analyze user criteria to deliver a subset of lenses to a user.

2. The computer readable storage medium of claim 1 further comprising executable instructions to deliver a subset of entities and a subset of entity classes.

3. The computer readable storage medium of claim 1, wherein each lens includes executable instructions to display to a user a subset of information from a data source in accordance with the data presentation directives.

4. The computer readable storage medium of claim 2, further comprising executable instructions to display the subset of entities, the subset of entity classes and the subset of lenses to the user.

5. The computer readable storage medium of claim 1, wherein the user criteria is selected from profile criteria, relevance criteria, access criteria and aesthetic criteria.

6. A computer readable storage medium, comprising executable instructions to:
associate with a first user, in accordance with first criteria, a first selection of entities and associated entity classes, each entity class having associated lenses;
associate with a second user, in accordance with second criteria, a second selection of entities and associated entity classes, each entity class having associated lenses;
wherein the first criteria and the second criteria is selected from profile criteria, relevance criteria, access criteria and aesthetic criteria.

7. The computer readable storage medium of claim 6, wherein each lens includes executable instructions to display to a user a subset of information from a data source in accordance with data presentation directives.

8. The computer readable storage medium of claim 6, wherein each lens includes metadata characterizing the data presentation directives.

9. A computer readable storage medium, comprising executable instructions to:
associate a first entity with first entity classes, wherein each first entity class has corresponding first entity data lenses;
associate a second entity with second entity classes, wherein each second entity class has corresponding second entity data lenses;
associate with a first user, in accordance with first criteria, a first subset of first entity classes and a first subset of first entity data lenses, and a first subset of second entity classes and a first subset of second entity data lenses; and
associate with a second user, in accordance with second criteria, a second subset of first entity classes and a second subset of first entity data lenses, and a second subset of second entity classes and a second subset of second entity data lenses.

10. The computer readable storage medium of claim 9, wherein the first criteria and the second criteria is selected from profile criteria, relevance criteria, access criteria and aesthetic criteria.

11. The computer readable storage medium of claim 9, wherein each data lens includes metadata characterizing data presentation directives.
